(19) United States
(12) Patent Application Publication
(10) Pub. No.: US 2011/0239407 A1
(43) Pub. Date: Oct. 6, 2011

(54) HINGE

(75) Inventor: Jung-Bin Chang, Tu-Cheng (TW)

(73) Assignee: HON HAI PRECISION INDUSTRY CO., LTD., Tu-Cheng (TW)

(21) Appl. No.: 12/768,707

(22) Filed: Apr. 27, 2010

(30) Foreign Application Priority Data
Mar. 30, 2010 (TW) 99205580

(51) Int. Cl. E05D 5/12

(52) U.S. Cl. 16/380

(57) ABSTRACT

A hinge includes a fixing member, a shaft non-rotatably fixed to the fixing member, and a rotating member. The shaft rod defines a flat surface. The rotating member includes a pivoting portion rotatably fitting about the shaft rod. The pivoting portion defines a cutout. When the rotating member is rotated relative to the fixing member, the flat surface is relatively rotated to align with the cutout, or face an inner wall of the pivoting portion.

### BACKGROUND

1. Technical Field

The disclosure relates to a hinge.

2. Description of Related Art

A collapsible device, such as a notebook computer, or a clamshell mobile phone, generally includes a main body hinged to a display.

The hinge includes a shaft sleeve, and a shaft rotatably received in the shaft sleeve. The shaft is in frictional engagement with an inner wall of the shaft sleeve during rotation of the shaft relative to the shaft sleeve. Therefore, the display can stay positioned at any angle with respect to the main body by friction between the shaft and the shaft sleeve. However, when opening or closing the display relative to the main body, the shaft and shaft sleeve have an invariant friction, which requires users to provide extra force to operate the display and occasionally they may inadvertently cause the display to strike the main body with too much force and thus shorten the life of the device. Therefore, it is inconvenient for users.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a hinge.

FIG. 2 is an assembled, isometric view of the hinge of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

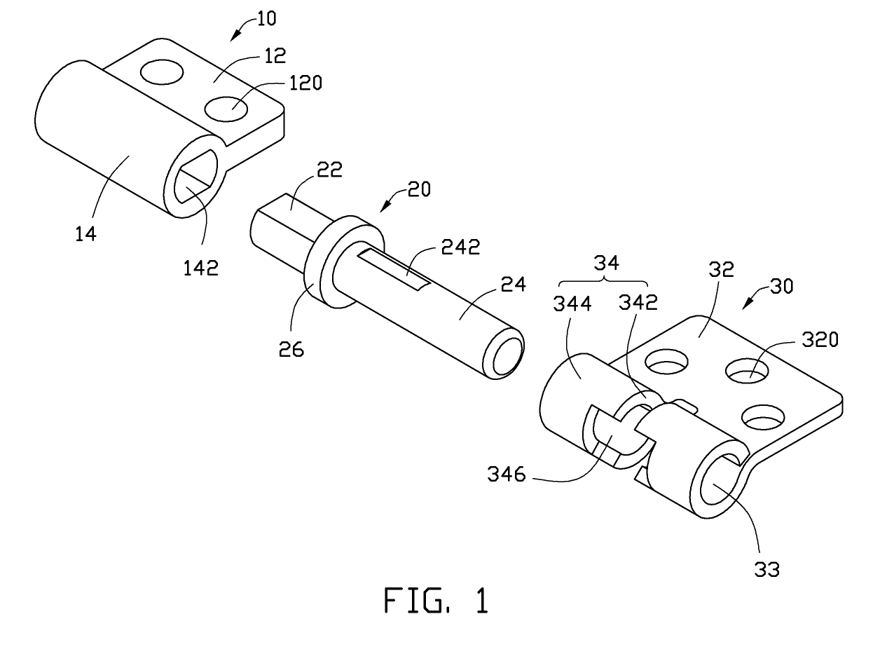

Referring to FIG. 1, in an exemplary embodiment, a hinge includes a fixing member 10, a shaft 20, and a rotating member 30.

The fixing member 10 includes a connecting portion 12 defining a plurality of fixing holes 120 therein, and a cylindrical mounting portion 14 located at a side of the connecting portion 12. The mounting portion 14 axially defines a double-D shaped engaging hole 142.

The shaft 20 includes a fixing portion 22, a shaft rod 24 opposite to the fixing portion 22, and a resisting portion 26 between the fixing portion 22 and the shaft rod 24. The fixing portion 22 has a double D-shaped cross-section, corresponding to the engaging hole 142 of the fixing member 10. The shaft rod 24 and the resisting portion 26 each have a circular cross-section, and the resisting portion 26 has a larger diameter than the shaft rod 24. A flat surface 242 is formed on a circumference of the shaft rod 24.

The rotating member 30 includes a fixing board 32 defining a plurality of fixing holes 320 therein, and a pivoting portion 34. An end of the fixing board 32 is curled to form the pivoting portion 34 and define a through hole 33 axially extending through opposite ends of the pivoting portion 34. The pivoting portion 34 defines a slot 342 around a circumference of the pivoting portion 34, communicating with the through hole 33, thereby, the pivoting portion 34 is divided into two sleeves 344 arranged along a same axis. Each sleeve 344 defines a cutout 346 facing and communicating with the slot 342. The cutouts 346 of the sleeves 344 are in alignment and communicate with each other.

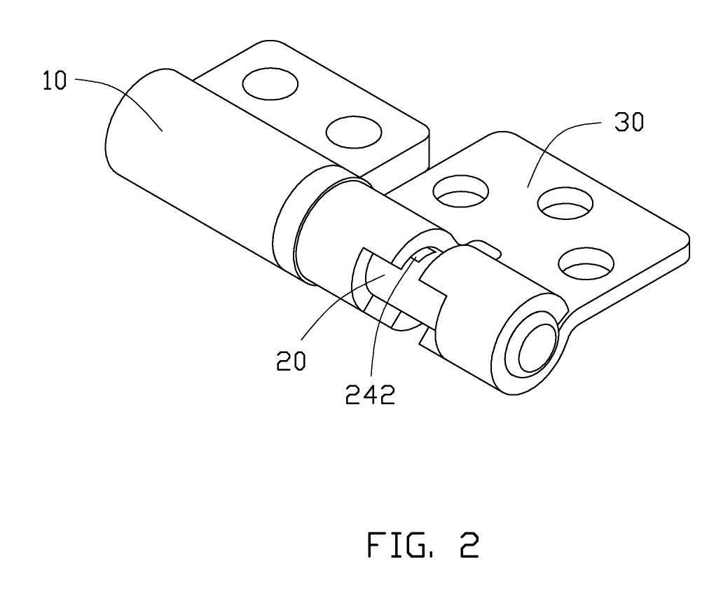

Referring to FIG. 2, in assembly, the fixing portion 22 of the shaft 20 is fixedly received in the engaging hole 142 of the fixing member 10. Thereby, the shaft 20 is non-rotatably fixed to the fixing member 10, with the resisting portion 26 of the shaft 20 abutting against an end of the mounting portion 14 of the fixing member 10. The shaft rod 24 of the shaft 20 is rotatably extended through the through hole 33 of the rotating member 30, so that the sleeves 344 are rotatably sleeved on the shaft rod 24, with the flat surface 242 of the shaft 20 facing an inner wall of one of the sleeves 344. In this state, a region of friction between the shaft rod 24 and the sleeves 344 is smaller.

In use, the above-mentioned hinge can be utilized in a collapsible device (not shown), such as a notebook computer, that includes a base (not shown) and a cover (not shown) hinged to the base. The rotating member 30 is fixed to the cover via the plurality of fixing holes 320. Correspondingly, the fixing member 10 is fixed to the base via the plurality of fixing holes 120. During opening the cover, the cover is rotated relative to the base, so that the rotating member 30 is rotated relative to the fixing member 10, with the sleeves 344 of the rotating member 30 rotating relative to the shaft rod 24 of the shaft 20. The shaft rod 24 is in frictional engagement with the inner wall of the sleeves 344, to maintain the rotating member 30 at any angle with respect to the fixing member 10. When the flat surface 242 of the shaft 20 is rotated to align with the cutouts 346 of the rotating member 30, the region of friction between the shaft rod 24 and the sleeves 344 becomes larger, resulting in increased friction between the shaft rod 24 and the sleeves 344. Therefore, the cover is easily maintained in a particular position.

When the cover is closed to being closed to the base, the flat surface 242 is rotated to face the inner wall of one of the sleeves 344. In this state, friction between the shaft rod 24 and sleeves 344 decreases, so that the cover is more easily closed without having to use so much pressure that the cover strikes against the base.

In other embodiments, the shaft rod 24 can define a plurality of flat surfaces 242, and the sleeves 344 of the rotating member 30 can define a plurality of cutouts 346. Therefore, the flat surfaces 242 can be rotated to align with the cutouts 346 or face the inner walls of the sleeves 344, to adjust friction between the shaft rod 24 and the sleeves 344.

It is believed that the present embodiment and its advantages will be understood from the foregoing description, and it will be apparent that various changes may be made thereto without departing from the spirit and scope of the description or sacrificing all of its material advantages, the example hereinbefore described merely being exemplary embodiment.

What is claimed is:

1. A hinge comprising:
a fixing member;
a shaft non-rotatably fixed to the fixing member, the shaft comprising a shaft rod defining at least one flat surface; and
a rotating member comprising a pivoting portion rotatably fitting about the shaft rod, the pivoting portion defining at least one cutout;
wherein when the rotating member is rotated relative to the fixing member, the at least one flat surface is relatively rotated to align with the at least one cutout, or face an inner wall of the pivoting portion.

2. The hinge of claim 1, wherein the pivoting portion defines a through hole, through which the shaft rod is rotatably extended, the at least one cutout communicates with the through hole.

3. The hinge of claim 2, wherein the pivoting portion defines a slot around a circumference of the pivoting portion and communicating with the through hole, the pivoting portion is divided into two sleeves via the slot.

4. The hinge of claim 3, wherein the sleeves have a same axis, the at least one cutout is defined in one of the sleeves, and extends to communicate with the slot.

5. The hinge of claim 1, wherein the rotating member comprises a fixing board, an end of the fixing board is curled to form the pivoting portion and define a through hole axially extending through opposite ends of the pivoting portion, for the shaft rod rotatably extending therethrough.

6. The hinge of claim 1, wherein the fixing member comprises a cylindrical mounting portion defining a double-D shaped engaging hole, the shaft comprises a fixing portion fixedly engaging in the engaging hole.
